(19) United States
(12) Patent Application Publication
(10) Pub. No.: US 2007/0226737 A1
(43) Pub. Date: Sep. 27, 2007

(54) Methods, systems, and storage mediums for monitoring and controlling command usage

(75) Inventors: Ruth L. Ferziger, San Jose, CA (US); Alejandro J. Furrer, San Jose, CA (US)

Correspondence Address: CANTOR COLBURN LLP - IBM TUSCON DIVISION, 55 GRIFFIN ROAD SOUTH, BLOOMFIELD, CT, 06002, US

(73) Assignee: INTERNATIONAL BUSINESS MACHINES CORPORATION, ARMONK, NY (US)

(21) Appl. No.: 11/386,618

(22) Filed: Mar. 22, 2006

(51) Int. Cl. G06F 9/46

(52) U.S. Cl. 718/100

(57) ABSTRACT

A method, system, and computer program product for monitoring and controlling command usage is provided. The method includes establishing a time threshold and acquiring a command for execution. The method also includes accessing a structure storing a first set of data for a most recently executed command, the first set of data including a time-stamp specifying the time of execution. The method further includes subtracting the time-stamp from a current time resulting in a time value, the current time designated for executing the command. If the time value meets or exceeds the time threshold, the method includes executing the command and storing a second set of data resulting from the executing and which includes a time stamp specifying the time of execution. If the time value neither meets nor exceeds the time threshold, the method includes maintaining the first set of data for the most recently executed command and aborting execution of the command.

### BACKGROUND OF THE INVENTION

1. Field of the Invention

This invention relates generally to system performance monitoring, and particularly to methods, systems, and computer program products for monitoring and controlling command execution at a multiprocessing system.

2. Description of Background

Before our invention, system testers and operators have reported that allowing certain commands to be issued at too frequent intervals (where too frequent can be dependent on the specific command) may cause performance degradation in certain mainframe subsystems. Among the conditions that cause this are hangs, whereby the system stops responding. Usually these hangs are a result of the command having obtained some resource (e.g., latches, locks, enqueues, etc.), which then cannot be obtained by other system processes. Further, system processing may be adversely affected (e.g., diminished processing speed) by this situation. In addition, some commands result in a large amount of output to the system console which can severely overload the ability to use the system console effectively.

In systems utilizing virtual storage access methods (VSAM), a ‘display contention’ command allows a system user to view perceived contention within the VSAM server. Depending on the level of contention that exists on the system at the time the command is issued, the result may be anything from a few lines of output to indicate that there is no contention to many, many lines of output describing the existing contention picture. Since it is unpredictable how much output may result from the issuance of the command, a mechanism is needed that would prevent this and other commands from being repeatedly issued within a certain amount of time.

### SUMMARY OF THE INVENTION

The shortcomings of the prior art are overcome and additional advantages are provided through the provision of methods, systems, and computer program products for monitoring and controlling command usage. The method includes establishing a time threshold and acquiring a command for execution. The method also includes accessing a structure storing a first set of data for a most recently executed command, the first set of data including a time-stamp specifying the time of execution. The method further includes subtracting the time-stamp from a current time resulting in a time value, the current time designated for executing the command. If the time value meets or exceeds the time threshold, the method includes executing the command and storing a second set of data resulting from the executing and which includes a time stamp specifying the time of execution. If the time value neither meets nor exceeds the time threshold, the method includes maintaining the first set of data for the most recently executed command and aborting execution of the command.

Additional features and advantages are realized through the techniques of the present invention. Other embodiments and aspects of the invention are described in detail herein and are considered a part of the claimed invention. For a better understanding of the invention with advantages and features, refer to the description and to the drawings.

Technical Effects

As a result of the summarized invention, technically we have achieved a solution which provides control over the execution of system commands in a multiprocessing environment that is based upon an established time threshold.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates one example of a block diagram upon which the command monitoring service may implemented in exemplary embodiments; and

FIG. 2 illustrates one example of a flow chart describing a process for implementing the command monitoring service in exemplary embodiments.

The detailed description explains the preferred embodiments of the invention, together with advantages and features, by way of example with reference to the drawings.

### DETAILED DESCRIPTION OF THE INVENTION

In accordance with exemplary embodiments, the command monitoring service enables an operator or user of a multiprocessing system to control the execution of system commands based upon an established time threshold.

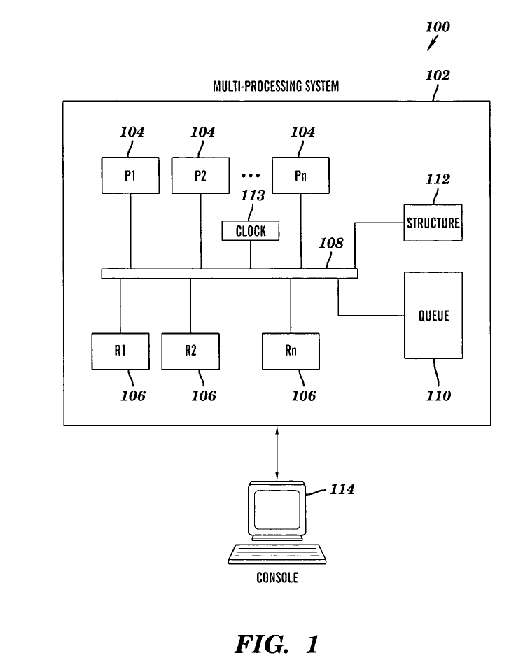

Turning now to the drawings in greater detail, it will be seen that in FIG. 1 there is a simplified system upon which the command monitoring service may be implemented in exemplary embodiments. The system 100 of FIG. 1 includes a multiprocessing system 102 and a console 114. In exemplary embodiments, multiprocessing system 102 comprises a computer system that utilizes multiple processors 104 or central processing units (CPUs), which execute, e.g., multiple, independent sequences of instructions in multiple contexts (also referred to as MIMD), a single sequence of instructions in multiple contexts (also referred to as SIMD), and multiple sequences of instructions in a single context (also referred to as MISD). The processors may be loosely or tightly coupled as dictated by business needs. Multi-processing system 100 may include a mainframe computer or similar type of system.

Multiprocessing system 102 also includes a plurality of resources 106. Resources 106 may include devices, such as printers, disk drives, memory, etc. Resources 106 may also include data, applications, routines, or any items subject to request by a processor. Resources 106 include log files that record events such as requests for access to a resource. The log files are routinely updated and provide useful information when analysis of system performance is desired. While shown in FIG. 1 as being internal to multiprocessing system 102, it will be understood that at least a portion of the resources 106 may be external to the multiprocessing system 102.

As shown in the multiprocessing system 102 of FIG. 1, a communications bus 108 is coupled to the processors 104 and the resources 106, thereby facilitating communication and access among these elements.

The multiprocessing system 102 also includes a queue 110 and a structure 112, both of which are shown to be in communication with processors 104 and resources 106 via communications bus 108. Queue 110 refers to a temporary storage location for housing commands and instructions that are utilized by one or more processors 104. In exemplary embodiments, structure 112 includes a storage location that houses data relating to previously executed commands. In particular, structure 112 stores information relating to one or more of the most recently executed commands as will be described further herein. In exemplary embodiments, structure 112 is internal to the multiprocessing system 102. However, it will be understood that structure 112 may alternatively be located in, e.g., an external memory location that is logically addressable by the multiprocessing system 102.

Multiprocessing system 102 executes an operating system (not shown) and a clock timer, or timing function 113. In addition, one or more of processors 104 execute logic for implementing the command monitoring service. These are described further herein.

Also included in the system 100 of FIG. 1 is a console 114. Console 114 may comprise a terminal in direct communication with the multiprocessing system 102 via, e.g., cabling or wireless elements. Console 114 includes input/output devices (e.g., keyboard, mouse, display) for sending and receiving communications. Console 114 may also include a processing device and software (e.g., operating system and applications). An operator of console 114 sends commands via the console 114 to the multiprocessing system 102. The operator may be a system tester, and information technology (IT) specialist, or similar type of individual that monitors and/or tests system performance. Depending upon the type of command, the multiprocessing system 102 may respond by providing output to the console 114.

In alternative exemplary embodiments, the multiprocessing system 102 may include the functionality described above with respect to the console 114, such that an operator issues commands directly from the multiprocessing system 102 itself.

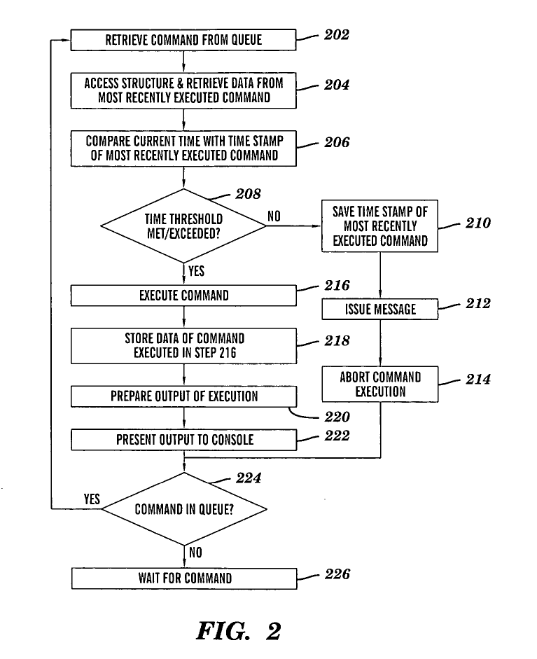

An operator of console 114 or other authorized individual may configure a desired time threshold usable by the command monitoring service in determining whether to execute an issued command. The command monitoring service may be implemented by one or more applications executing on the multi-processing system 102. Turning now to FIG. 2, a process for implementing the command monitoring service will now be described in accordance with exemplary embodiments. The flow diagram provided in FIG. 2 assumes that a time threshold has been set and that an operator of console 114 has issued a command.

At step 202, the command is retrieved from queue 110. The command monitoring service accesses structure 112 and retrieves data relating to the most recently executed command at step 204. The data includes a time stamp specifying the time that the command was executed. The data may also include a command type. For example, the command type may be directed to system contention and the operator desires to view details of the contention for analysis. The command may be issued via the operating system, a system utility tool, log file analysis tool, or other means. By classifying the commands by command type, the command monitoring service enables an operator to specify multiple time thresholds for different command types. In addition, the classification of command types enable the time threshold to be applied only to specified commands.

At step 206, the command monitoring service compares the current time (e.g., via the clock function 113) with the time stamp of the most recently executed command. If the command type feature is used, then the command monitoring service may compare the current time to the time stamp of the most recently executed command that shares the same command type as the command to be executed.

At step 208, it is determined if the time threshold has been met or exceeded. This may be accomplished by subtracting the time stamp of the most recently executed command from the current time. If the threshold has not been met, then this means that a minimum amount of time between the two commands has not elapsed (i.e., the two commands are too close together in time). At step 210, the time stamp of the most recently executed command is maintained in the structure 112. The command monitoring service issues a message to the operator at console 114 notifying the operator that the time threshold has not been met and that the requested command will not be executed at step 212. At step 214, the command monitoring service aborts the command execution by deleting the command from the queue 110.

Returning to step 208, if the threshold has been met or exceeded, then the command is transmitted through the normal channels (e.g., on to one of processors 104) for execution at step 216. The command monitoring service stores data relating to the command in structure 112 at step 218. The data includes a time stamp specifying the time that the command was executed. The data may also include the command type.

At step 220, the results of the command execution are prepared by the multiprocessing system 102 and presented to the console 114 at step 224. Regardless of whether the command was executed (via steps 216-222) or aborted (via steps 210-214), it is then determined whether another command is in the queue 110 at step 224. If so, the process returns to step 202. Otherwise, the process proceeds to step 226 whereby the command monitoring service waits for the next command.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for monitoring and controlling command usage, comprising:
establishing a time threshold;
acquiring a command for execution;
accessing a structure storing a first set of data for a most recently executed command, the first set of data including a time-stamp specifying the time of execution;
subtracting the time-stamp from a current time resulting in a time value, the current time designated for executing the command;
if the time value meets or exceeds the time threshold:
executing the command; and
storing, in the structure, a second set of data, the second set of data resulting from the executing and including a time stamp specifying the time of execution; and
if the time value neither meets nor exceeds the time threshold:
maintaining the first set of data for the most recently executed command including the time stamp; and
aborting execution of the command.

2. The method of claim 1, wherein if the time value meets or exceeds the time threshold, the method further comprises:
preparing output resulting from execution of the command; and
presenting the output to an issuer of the command.

3. The method of claim 1, wherein the first and second sets of data include a command type.

4. The method of claim 3, wherein the command type is a request to view details of a contention issue.

5. The method of claim 1, wherein the time threshold is specified in seconds.

6. A multi-processing system including a clock, memory, a communications bus, and a plurality of processors and resources in communication with each other via the communications bus, comprising:
a queue storing a command for execution, the queue in communication with the communications bus;
a storage structure in communication with the communications bus, the storage structure storing a first set of data for a most recently executed command, the first set of data including a time-stamp specifying the time of execution; and
logic executing via the multi-processing system for performing:
establishing a time threshold;
acquiring the command from the queue;
accessing the first set of data from the structure;
subtracting the time stamp of the first set of data from a current time resulting in a time value, the current time designated for executing the command;
if the time value meets or exceeds the time threshold:
executing the command; and
storing a second set of data in the storage structure, the second set of data resulting from the executing and including a time stamp specifying the time of execution;
if the time value neither meets nor exceeds the time threshold:
maintaining, in the storage structure, the first set of data for the most recently executed command including the time stamp; and
aborting execution of the command.

7. The system of claim 6, wherein if the time value meets or exceeds the time threshold, the logic further performs:
preparing output resulting from execution of the command; and
presenting the output to an issuer of the command.

8. The system of claim 6, wherein the first and second sets of data include a command type.

9. The system of claim 8, wherein the command type is a request to view details of a contention issue.

10. The system of claim 6, wherein the time threshold is specified in seconds.

11. A computer program product for monitoring and controlling command usage, the computer program product including instructions for implementing a method, comprising:
establishing a time threshold;
acquiring a command for execution;
accessing a structure storing a first set of data for a most recently executed command, the first set of data including a time-stamp specifying the time of execution;
subtracting the time-stamp from a current time resulting in a time value, the current time designated for executing the command;
if the time value meets or exceeds the time threshold:
executing the command; and
storing, in the structure, a second set of data, the second set of data resulting from the executing and including a time stamp specifying the time of execution; and
if the time value neither meets nor exceeds the time threshold:
maintaining the first set of data for the most recently executed command including the time stamp; and
aborting execution of the command.

12. The computer program product of claim 11, wherein if the time value meets or exceeds the time threshold, the method further comprises:
preparing output resulting from execution of the command; and
presenting the output to an issuer of the command.

13. The computer program product of claim 11, wherein the first and second sets of data include a command type.

14. The computer program product of claim 13, wherein the command type is a request to view details of a contention issue.

15. The computer program product of claim 13, wherein the time threshold is specified in seconds.
